(19) United States
(12) Patent Application Publication
(10) Pub. No.: US 2008/0098191 A1
(43) Pub. Date: Apr. 24, 2008

(54) DETERMINING CODE EFFICIENCY BY MONITORING MEMORY REALLOCATION

(75) Inventor: Kirk J. Krauss, Los Gatos, CA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/551,280

(22) Filed: Oct. 20, 2006

(51) Int. Cl. G06F 12/00

(52) U.S. Cl. 711/170

(57) ABSTRACT

A method for use of a diagnostic software tool that can allow software developers to track the number of times each memory block is enlarged, and highlight the most frequently enlarged memory blocks. In this regard, in better understanding the performance characteristics of memory reallocation a developer can use this method to identify and implement better coding techniques to improve code efficiency and reduce the processing time utilized for memory reallocations. In addition, graphs can be generated to indicate the time/CPU utilization dedicated to the memory reallocation process.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method for using a diagnostic software tool that allows a software developer to track the number of times each memory block is enlarged, and highlights the most frequently enlarged memory blocks, and in particular, to identifying to the software developer areas in code where coding reliability and or efficiency improvements can be made to reduce the processing time utilized for memory reallocations.

2. Description of Background

Application developers sometimes attempt to conserve virtual memory by allocating memory blocks that may or may not be too small for their intended purposes. In general, memory blocks may be repetitively enlarged in small increments via reallocation, whenever the need arises. The resulting application programs may also reallocate memory blocks frequently. Processing time is consumed each time memory is allocated, reallocated, and or moved. As memory manipulations occur excessively, the performance of the software and as such the system in general can be degraded.

The performance impact of repeating reallocations can depend on the state of the underlying heap. If the heap manager needs to move a memory block to a new virtual address range to accommodate the block's enlargement, then the act of copying the block's contents, from a central processing unit (CPU) processor time and performance perspective, can be costly. If the heap manager needs to commit additional virtual memory to provide space for a moved block, the performance costs can increase further. In addition, the empty space that remains after a block has been moved may not be filled until another block of the original size or a smaller size is allocated. Because of these factors, reallocation can cause intrablock waste, heap fragmentation, and reduced performance.

### SUMMARY OF THE INVENTION

The shortcomings of the prior art are overcome and additional advantages are provided through the provision of a method of determining code efficiency by monitoring memory reallocation, the method comprising tracking a plurality of memory blocks allocated and or deallocated; incrementing a reallocation count associated with a specific one of the plurality of memory blocks when a memory reallocation occurs; incrementing a move count associated with a specific one of the plurality of memory blocks when a memory move occurs; and displaying, when a heap snapshot and end-of-run occurs, an object reference graph view highlighting the plurality of memory blocks with the highest reallocation count, and highest move count.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which is a method of determining code efficiency by monitoring memory reallocation within a software application that is analyzed at runtime.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a diagnostic routine for determining code efficiency by monitoring heap memory activity; and

FIG. 2 illustrates one example of a diagnostic routine for displaying the profiling results of heap memory activity.

The detailed description explains the preferred embodiments of the invention, together with advantages and features, by way of example with reference to the drawings.

### DETAILED DESCRIPTION OF THE INVENTION

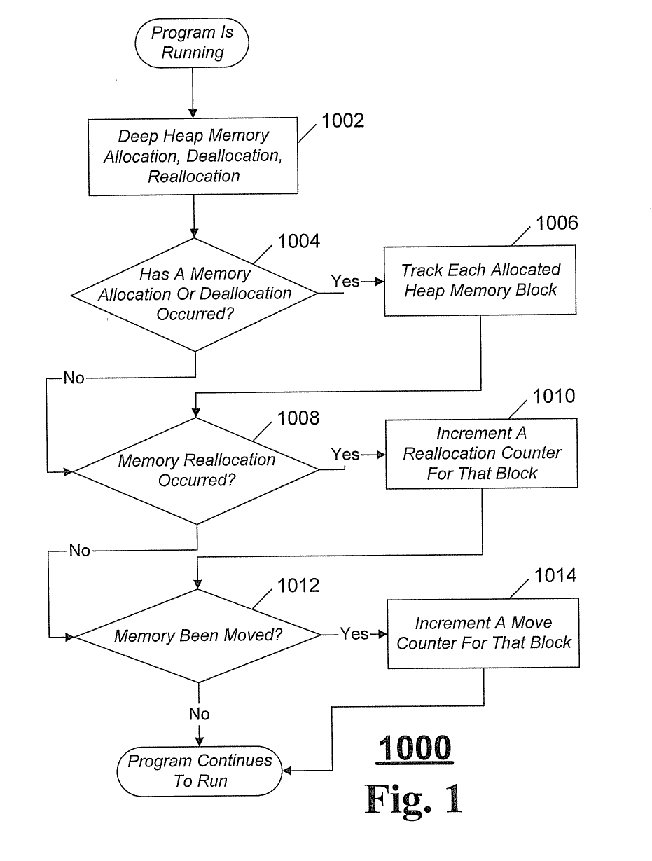

Turning now to the drawings in greater detail, it will be seen that in FIG. 1 there is illustrated one example of a diagnostic routine for determining code efficiency by monitoring memory reallocation.

A general-purpose profiling tool, when applied to a software application under test, may indicate overall time spent in methods, or intrablock waste within heap memory blocks, or fragmentation of heap regions. However, no such diagnostic tool can signal the combined set of problems caused by recurring memory block enlargement. An application that frequently reallocates memory may suffer from heap fragmentation and performance degradation, depending on its runtime conditions, input data, and other factors. Even when such an application seems to perform well and shows encouraging profiling results in a test setting, it may perform poorly when it is deployed.

In an exemplary embodiment of the present invention, a diagnostic routine is used to determine and display the most frequently enlarged memory blocks. In this regard, the routine tracks the number of times each memory block is enlarged, and then highlights the most frequently enlarged block(s) on the object reference graph. As such, a software engineer and or a programmer can utilize the results of the diagnostic routine to identify and make changes to the code of the software application under test, in an effort to minimize the amount of processing time consumed and or number of occurrences encountered by memory manipulations, thus improving reliability, efficiency, and performance of the software application under test.

Referring to FIG. 1 there is illustrated one example of a diagnostic routine for determining code efficiency by monitoring heap memory activity. In an exemplary embodiment, the routine intercepts malloc( ), realloc( ) and other heap memory allocation and deallocation application programming interface (API) functions. The routine tracks each heap memory block that is allocated, when a block is reallocated a reallocation counter is incremented for that block, and if a block is moved to make room for enlargement, a move counter is incremented for that block. The method begins with the program running in block 1002.

In block 1002 heap memory is allocated, deallocated, and or reallocated by the application under test. Processing then moves to decision block 1004.

In decision block 1004 a determination is made as to whether or not a memory allocation or deallocation occurred. If the resultant is in the affirmative that a memory allocation and or deallocation occurred then processing moves to block 1006. If the resultant is in the negative that a memory allocation or deallocation did not occur then processing moves to decision block 1008.

In block 1006 each allocated heap memory block is tracked. Processing then moves to decision block 1008.

In decision block 1008 a determination is made as to whether or not a memory reallocation occurred. If the resultant is in the affirmative that a memory reallocation occurred then processing moves to block 1010. If the resultant is in the negative that a memory reallocation did not occur then processing moves to decision block 1012.

At block 1010 a reallocation counter for that block is incremented. Processing then moves to decision block 1012.

In decision block 1012 a determination is made as to whether or not memory has been moved. If the resultant is in the affirmative that memory has been moved then processing moves to block 1014. If the resultant is in the negative that memory has not been moved then the program continues to run and the routine is exited.

In block 1014 a move counter for that block is incremented and the program continues to run after the routine is exited.

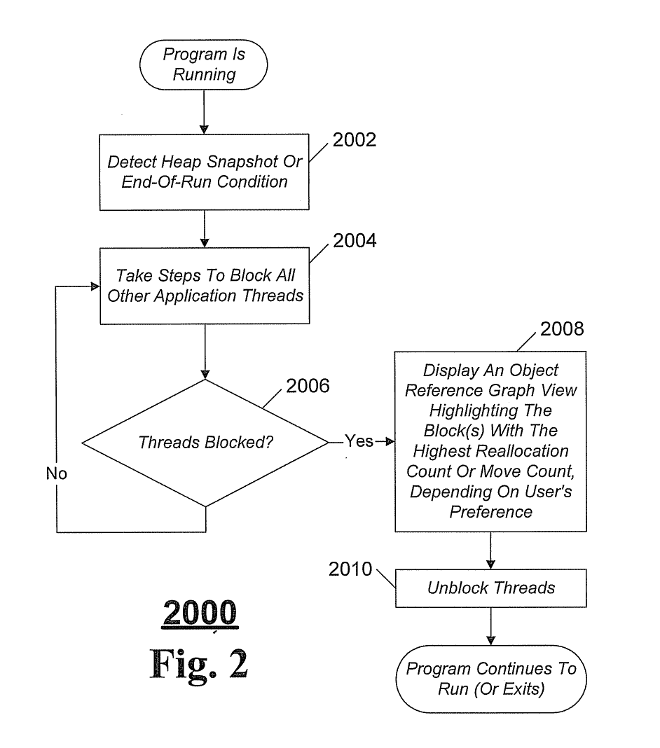

Referring to FIG. 2 there is illustrated a diagnostic routine for displaying the profiling results of heap memory activity. In an exemplary embodiment when a heap snapshot occurs, or at the end-of-run, an object reference graph view highlighting the block(s) with the highest reallocation count and or move count is displayed. The method begins with the program running in block 2002.

In block 2002 a snapshot or end-of-run condition is detected. Processing then moves to block 2004.

In block 2004 processing takes steps to block all other application threads. Processing then moves to decision block 2006.

In decision block 2006 a determination is made as to whether or not the threads have been blocked. If the resultant is in the affirmative that is the threads have been blocked then processing moves to block 2008. If the resultant is in the negative that is the threads have not been blocked then processing returns to block 2004.

In block 2008 an object reference graph view highlighting the block(s) with the highest reallocation count or move count is displayed. Such display can be in accordance with any user preference settings. Processing then moves to block 2010.

In block 2010 the other application threads previously blocked are unblocked. The program continues to run or exits after the routine is exited.

In an exemplary embodiment, because some developers will want to understand the performance characteristics of their reallocation scenarios in a test setting, this method could be implemented as part of a general-purpose performance profiling tool such as IBM RATIONAL QUANTIFY, a member of the IBM PURIFY PLUS product family. QUANTIFY provides a call graph that shows the amount of time spent in each method of a profiled application. A “Highlight:” pull down menu in QUANTIFY allows users to select subsets of the call graph that are expensive in various ways. If QUANTIFY is modified to do PURIFY-style memory tracking, then a QUANTIFY call graph could be informed by this reallocation-tracking method of the present invention. The method(s) responsible for repetitive reallocations could be highlighted. A QUANTIFY user could then select the highlighted method(s) to show the amount of time spent performing those reallocations.

Furthermore, like “classic” PURIFY, QUANTIFY also does not currently provide an object reference graph. Both PURIFY-style memory tracking and PURIFY for Java's object reference graph would be needed in QUANTIFY, in order to show both block reallocation counts and the method performance data outlined in the previous paragraph, all in one tool.

In another exemplary embodiment, in integrating this method into QUANTIFY one might want to associate tracked memory blocks with the methods shown in QUANTIFY's call graph. The simplest way to make this association might be to track each block's “allocation location”, as PURIFY does today, and to search the call graph for the node that corresponds to the most frequently enlarged block(s). An internal set of links between each call graph node and a list of associated tracked memory blocks might prove to be highly reliable but would also require more memory overhead for QUANTIFY.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of determining code efficiency by monitoring memory reallocation, said method comprising:
tracking a plurality of memory blocks allocated and deallocated;
incrementing a reallocation count associated with a specific one of said plurality of memory blocks when a memory reallocation occurs;
incrementing a move count associated with a specific one of said plurality of memory blocks when a memory move occurs; and
displaying, when a heap snapshot and end-of-run occurs, an object reference graph view highlighting said plurality of memory blocks with highest said reallocation count, and highest said move count.

2. The method in accordance with claim 1, wherein said plurality of memory blocks reside in heap memory.

3. The method in accordance with claim 2, wherein tracking a plurality of memory blocks includes intercepting malloc( ) commands.

4. The method in accordance with claim 3, wherein tracking a plurality of memory blocks includes intercepting realloc( ) commands.

5. The method in accordance with claim 4, wherein tracking a plurality of memory blocks includes intercepting heap memory allocation and deallocation API functions.

6. The method in accordance with claim 5, wherein displaying when a heap snapshot, and end-of-run occurs includes displaying the data in accordance with user preferences.
